(19) United States
(12) Patent Application Publication
(10) Pub. No.: US 2024/0068501 A1
(43) Pub. Date: Feb. 29, 2024

(54) Corner Engage Clip with Integral Support Flange

(71) Applicant: Illinois Tool Works Inc., Glenview, IL (US)

(72) Inventor: Mark A. Beyer, Armada, MI (US)

(21) Appl. No.: 18/237,716

(22) Filed: Aug. 24, 2023

Related U.S. Application Data
(60) Provisional application No. 63/402,500, filed on Aug. 31, 2022.

(51) Int. Cl. F16B 37/08

(52) U.S. Cl. CPC F16B 37/0842

(57) ABSTRACT

Disclosed is a push-in fastener assembly for attaching a first component having a first opening relative to a second component having a second opening. The push-in fastener assembly includes a fastener and a push-in retainer. The fastener has a head and a threaded shank. The push-in retainer has a cross member having a female fastener portion configured to engage the threaded shank. A pair of retaining legs are resiliently connected to the cross member. The pair of retaining legs includes a first retaining leg and a second retaining leg. One or more downturn flanges coupled to the cross member and extending downwardly from cross member to engage a portion of the first retaining leg or the second retaining leg. Each of the first retaining leg and the second retaining leg includes a shelf that biases a respective one of the first retaining leg and the second retaining leg outwardly once the threaded shank passes through the female fastener portion.

### RELATED APPLICATIONS

The present application claims priority to U.S. Provisional Patent Application No. 63/402,500, filed Aug. 31, 2022; which is hereby incorporated by reference in its entirety.

### BACKGROUND

Automotive components require fastening techniques that are simple to manufacture and assemble. Further, fastening techniques should above all be reliable and efficient. A push-in fastener, also known as a push-in nut or push-on nut, is a type of hardware component used to create a threaded connection in component, including panels fabricated from sheet metal, plastic, or other thin materials.

A push-in fastener is designed to provide a reliable and efficient method for attaching components without the need for additional tools like screws or bolts. Push-in fasteners can be used where quick and reliable fastening is required as they save time and effort by eliminating the need for traditional threaded fasteners and reducing the complexity of installation.

Existing solutions, however, can suffer from various deficiencies, such as a failure or damage at the opening in a panel. Therefore, despite advancements to date, it would be highly desirable to have a push-in fastener to more reliably join two or more components, such as vehicle components.

### SUMMARY

The present disclosure relates generally to a fastening system to form a connection between two components, such as vehicular components, using a push-in fastener, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric assembly view of the fastening system in accordance with an aspect of this disclosure, while FIG. 1b illustrates an isometric assembled view of the fastening system of FIG. 1a.

FIG. 1c illustrates a first elevation side view of the fastening system of FIG. 1a, while FIG. 1d illustrates a second elevation view of the fastening system of FIG. 1a.

FIG. 1e illustrates a top plan view of the fastening system of FIG. 1a, while FIG. 1f illustrates a bottom plan view of the fastening system of FIG. 1a.

FIG. 2a illustrates a topside isometric view of the push-in retainer, while FIG. 2b illustrates an underside isometric view of the push-in retainer.

FIGS. 2c through 2f illustrates first, second, third, and fourth elevation side view of the push-in retainer.

FIGS. 2g and 2h illustrate, respectively, top and bottom plan views of the push-in retainer.

FIG. 3a illustrates a cross-sectional side view of the fastening system taken along cutline A-A (FIG. 1e), while FIG. 3b illustrates a cross-sectional perspective view of the fastening system taken along cutline A-A (FIG. 1e).

FIG. 3c illustrates a perspective view of the push-in retainer, while FIG. 3d illustrates a cross-sectional perspective view of the push-in retainer taken along cutline B-B (FIG. 3c).

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a push-in fastener assembly having a fastener and a push-in retainer. The push-in retainer comprises a downturn flange, which nests in a recessed cross member at or near an upper end of the retaining legs. In operation, the downturn flange operates to support the retaining legs during extraction because the downturn flanges are contact the edges of the component (e.g., panel). The push-in retainer provides a rigid support to prevent the retaining legs from bending outward. In addition, the contour of the cross member at or near the top of the retaining legs also provides additional strength and rigidity as compared to a linear section.

As noted, existing solutions for push-in fastener assemblies suffer from various deficiencies, such as a failure at the opening in the component. By shifting the point(s) of engagement with the opening closer to the corners of the opening, the component is more likely to withstand higher loading before deflection. Thus, an advantage of the disclosed push-in fastener assembly is that the forces are distributed closer to one or more corners of the opening, which is typically stronger than the area in the center of the opening.

In one example, a push-in retainer for attaching a first component having a first opening relative to a second component having a second opening via a fastener comprises: a cross member having a female fastener portion configured to engage a threaded shank of the fastener; a pair of retaining legs resiliently connected to the cross member, wherein the pair of retaining legs comprises a first retaining leg and a second retaining leg; and one or more downturn flanges coupled to the cross member and extending downwardly from cross member to engage a portion of the first retaining leg or the second retaining leg.

In another example, a push-in retainer for attaching a first component having a first opening relative to a second component having a second opening via a fastener comprises: a cross member having a female fastener portion configured to engage a threaded shank of the fastener; a pair of retaining legs resiliently connected to the cross member, wherein the pair of retaining legs comprises a first retaining leg and a second retaining leg, and wherein each of the first retaining leg and the second retaining leg comprises a first leg section and a second leg section resiliently connected to one another via a connecting portion; and one or more downturn flanges coupled to the cross member and extending downwardly from cross member to engage the second leg section of the first retaining leg or the second retaining leg to limit outward flex of the second leg section relative to the first leg section via the connecting portion.

In yet another example, push-in fastener assembly for attaching a first component having a first opening relative to a second component having a second opening comprises: a fastener having a head and a threaded shank; and a push-in retainer having a cross member having a female fastener portion configured to engage the threaded shank, a pair of retaining legs resiliently connected to the cross member, wherein the pair of retaining legs comprises a first retaining leg and a second retaining leg, and one or more downturn flanges coupled to the cross member and extending downwardly from cross member to engage a portion of the first retaining leg or the second retaining leg, wherein each of the first retaining leg and the second retaining leg comprises a shelf, wherein the shelf is configured to bias a respective one of the first retaining leg and the second retaining leg outwardly once the threaded shank passes through the female fastener portion.

In some examples, the downturn flange overlaps or otherwise envelopes the portion of the first retaining leg or the second retaining leg.

In some examples, each of the first retaining leg and the second retaining leg comprises a first leg section and a second leg section resiliently connected to one another via a connecting portion. The downturn flange may be configured to limit outward flex of the second leg section relative to the first leg section via the connecting portion.

In some examples, the cross member includes one or more spring flanges. The one or more spring flanges may be configured to increase a contact area footprint with the second component to mitigate risk of damage thereto. The one or more spring flanges may be configured to absorb movement between the first component and the second component.

In some examples, the push-in retainer is a stamped-metal component.

In some examples, each of the first retaining leg and the second retaining leg comprises a shelf, wherein the shelf is configured to bias a respective one of the first retaining leg and the second retaining leg outwardly once the threaded shank passes through the female fastener portion.

In some examples, the second leg section includes at least one wing configured to engage the second opening.

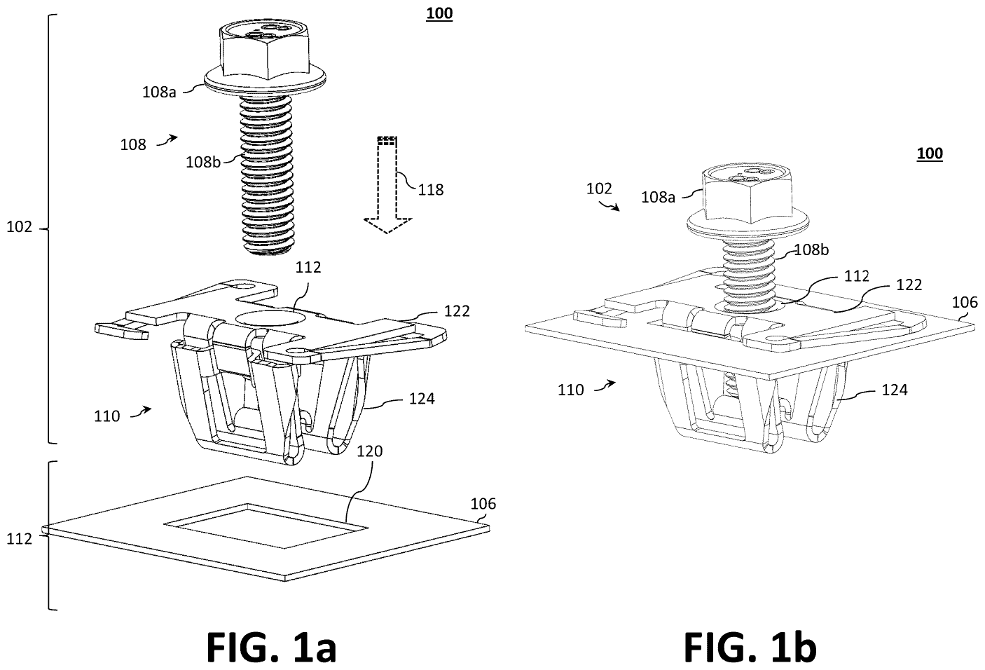

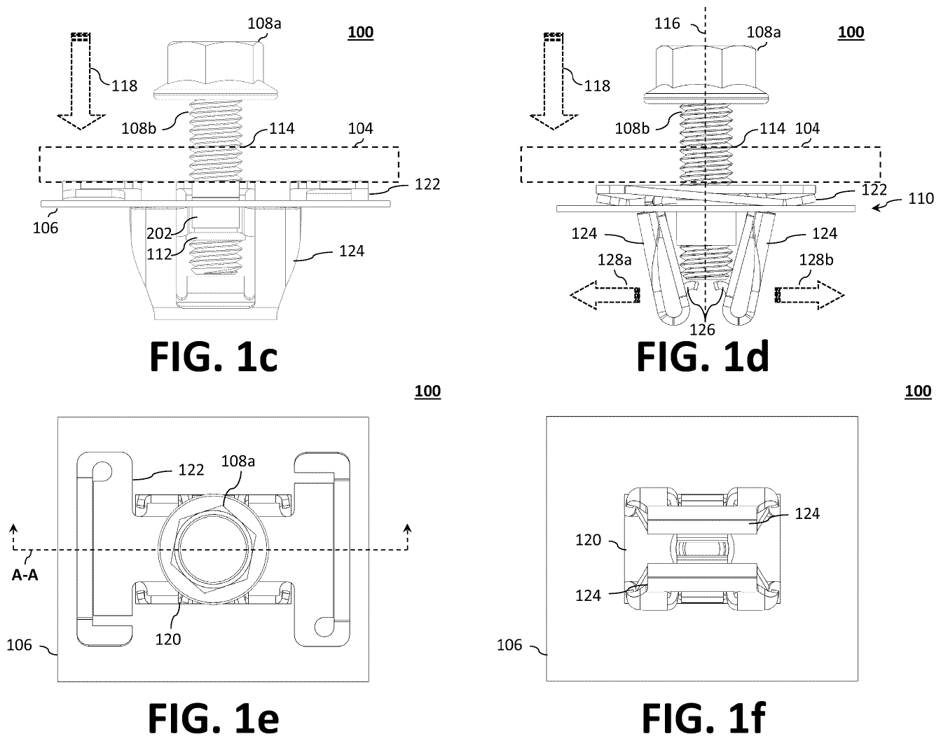

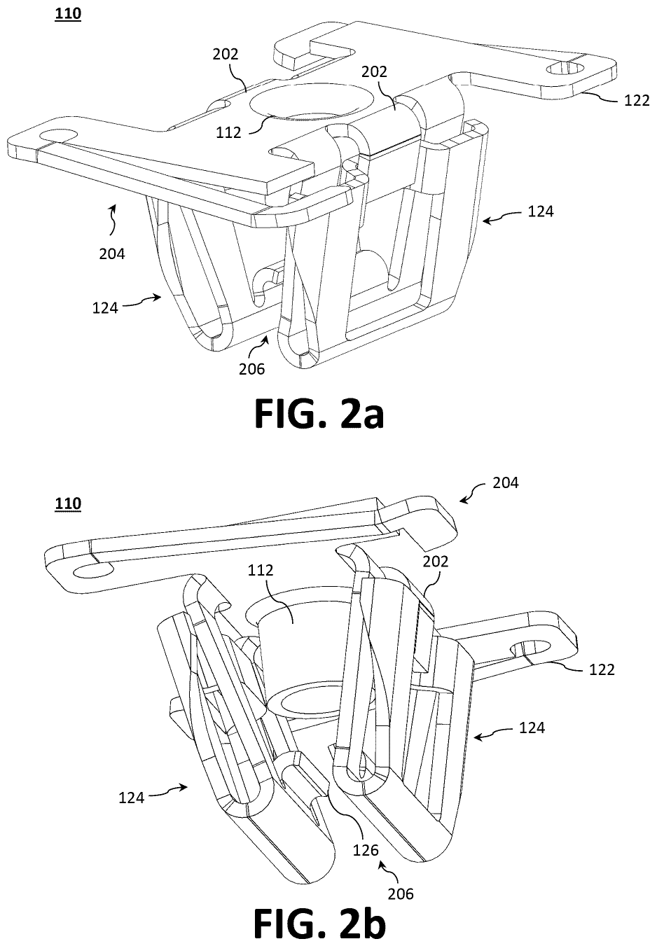

FIG. 1a illustrates an isometric assembly view of the fastening system 100 in accordance with an aspect of this disclosure, while FIG. 1b illustrates an isometric assembled view of the fastening system 100. FIG. 1c illustrates a first elevation side view of the fastening system 100, while FIG. 1d illustrates a second elevation view thereof. FIG. 1e illustrates a top plan view of the fastening system 100, while Figure if illustrates a bottom plan view of the fastening system 100. The illustrated fastening system 100 includes the first component 104, the second component 106, and a push-in fastener assembly 102. The push-in fastener assembly 102 is configured to join the first component 104 and the second component 106.

To facilitate attachment via the push-in fastener assembly 102, each of the first component 104 and the second component 106 includes one or more engagement features. For example, the first component 104 is illustrated as having a first opening 114 formed therein and the second component 106 is illustrated as having a second opening 120 formed therein. The first opening 114 and the second opening 120 can be formed in the respective first component 104 or second component 106 during manufacturing thereof or added post-manufacture through a mechanical process (e.g., drilling, cutting, carving, etc.). After the first component 104 and the second component 106 are assembled, as best illustrated in FIGS. 1c and 1d, the second component 106 is covered at least partially by the first component 104.

The push-in fastener assembly 102 is illustrated as a multi-component push-in fastener assembly 102 having a male fastener 108 and a push-in retainer 110 (e.g., a metal retainer clip) defining a female fastener portion 112 (e.g., an internally-threaded component). The female fastener portion 112 can define an internally-threaded bore configured to threadedly engage the threaded shank 108b. The push-in retainer 110 serves to mechanically engage and couple with the second component 106 via the second opening 120, while the male fastener 108 and the female fastener portion 112 serves to engage one another.

In the illustrated example, the push-in retainer 110 generally comprises a cross member 122 and one or more retention features, which are illustrated as a set of retaining legs 124. As illustrated, the set of retaining legs 124 are resilient connected to and protrude from an underside surface of the cross member 122 and to engage the second opening 120.

As will be described in greater detail in connection with the remaining Figures, the push-in fastener assembly 102 includes one or more features to improve engagement with and retention relative to the second component 106. In the illustrated example, the male fastener 108 comprises a head 108a and a threaded shank 108b (e.g., an externally-threaded shaft with a head, such as a bolt). While the head 108a is illustrated as a hex head, other shapes are contemplated (e.g., square, slotted, Philips, etc.).

It is contemplated that certain components of the multi-component push-in fastener assembly 102 may be fabricated as a stamped-metal component using a metal-stamping technique. For example, the push-in retainer 110 can be fabricated from a single sheet of metal and stamped/bent using a metal-stamping technique to form and/or defied its various features. For example, the female fastener portion 112 could be cold pressed and/or extruded and subsequently threaded to define the internally-threaded bore, while the male fastener 108 can be fabricated from metal via one or more metal-shaping techniques, such as cold forging.

In another example, the push-in retainer 110 can be fabricated as a stamped-metal component, whereas the male fastener 108 can be fabricated from a plastic material using a plastic injection technique, additive manufacturing, or otherwise. In some examples, one or more components of the push-in fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, door trim panels, moldings, trim pieces, and other substrates (whether used as interior or exterior surfaces). The second component 106 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

During installation, as best illustrated in FIG. 1a, the push-in retainer 110 is inserted into the second opening 120 of the second component 120 in the direction indicated by arrow 118. The second opening 120 is sized and shaped to receive and retain the push-in retainer 110. In the illustrated example, the second opening 120 is generally rectangular.

Once the push-in retainer 110 is installed, an end of the male fastener 108 is passed through the first opening 114 formed in the first component 104 in the direction indicated by arrow 118 to threadedly engage the female fastener portion 112 formed in the push-in retainer 110, thus ultimately engaging and retaining the push-in retainer 110. The male fastener 108 can be rotated relative to the female fastener portion 112 about an axis of rotation 116 to join and compress the first component 104 between the head 108a of the male fastener 108 and the second component 106/push-in retainer 110.

As the male fastener 108 rotates about the axis of rotation 116, the distal end of the threaded shank 108b travels in the direction of arrow 118 to engage one or more shelves 126 formed on one or both of the set of retaining legs 124. While two shelves 126 are illustrated, a single shelf 126 can be employed where desired (e.g., if only one retaining leg 124 is to be biased). As the threaded shank 108b pushes against the one or more shelves 126, the retaining legs 124 are biased away from the axis of rotation 116 (and one another) as indicated by arrows 128a, 128b. In addition to increasing the gap between the set of retaining legs 124, biasing the set of retaining legs 124 outwardly causes the set of retaining legs 124 to push against the underside of the second component 106, thus increasing the connection between the push-in retainer 110 and the second component 106.

Where desired, the male fastener 108 can be removed by rotating the male fastener 108 about an axis of rotation 116 in an opposition direction, thus causing the distal end of the threaded shank 108b to travel in a direction opposite that of arrow 118 to ultimately disengage one or more shelves 126. Once disengaged, the set of retaining legs 124 is free to return toward the axis of rotation 116 to resume its originally position and to facilitate removal of the push-in retainer 110 from the second opening 120 of the second component 106.

In some examples, the push-in fastener assembly 102 may comprise a seal when desirable to mitigate dust, dirt, and/or moisture penetration through the second opening 120. The seal may be embodied as a ring (e.g., an annulus) and fabricated from foam material, thermoplastic, rubber, etc. For example, a seal can be configured to surround a portion of the male fastener 108 (e.g., the threaded shank 108b) and positioned between the second component 106 and the female fastener portion 112.

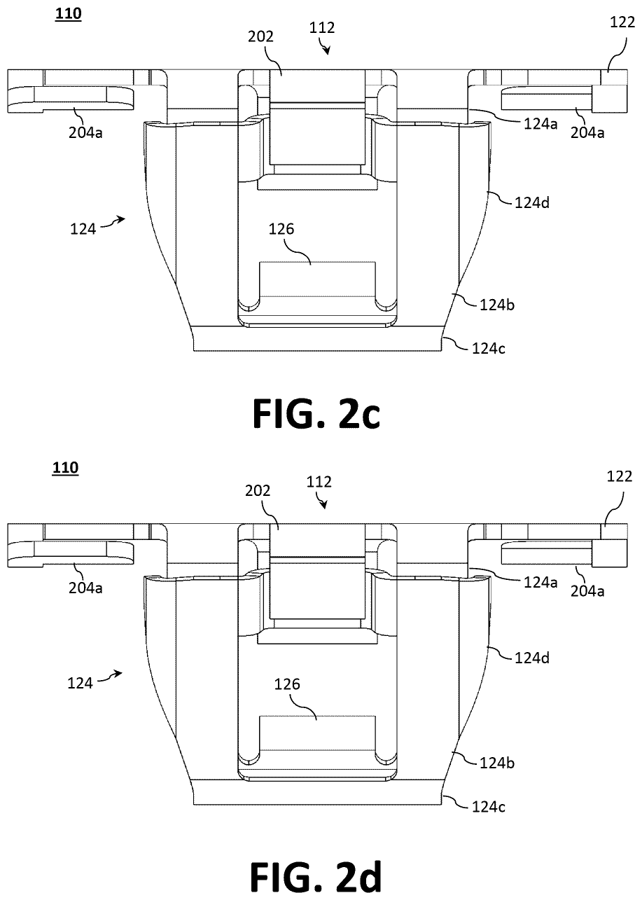

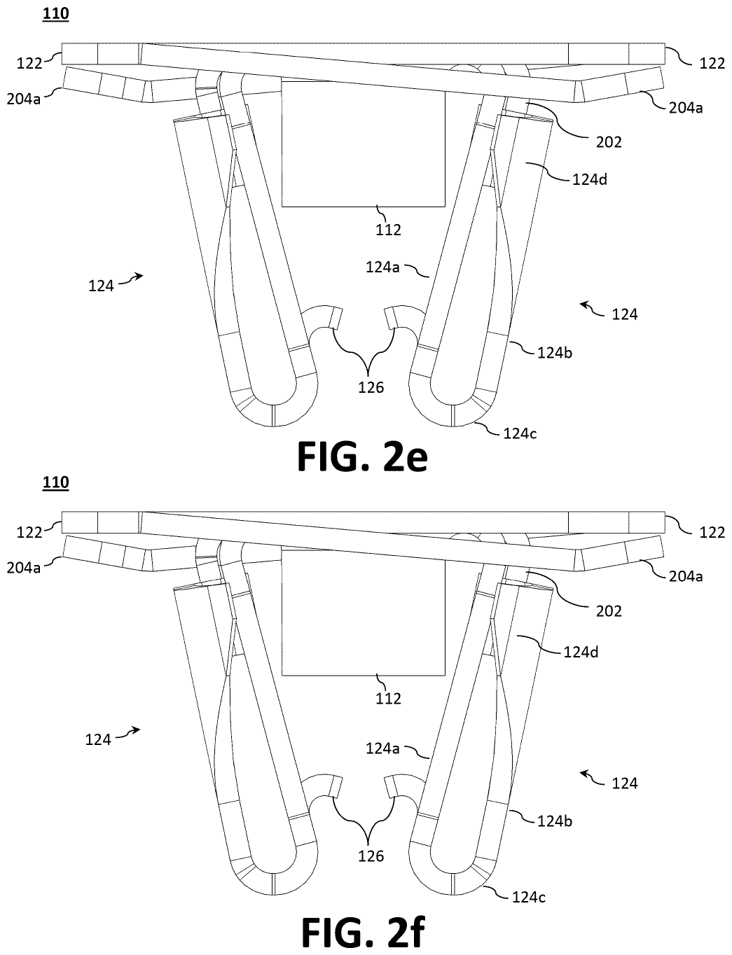

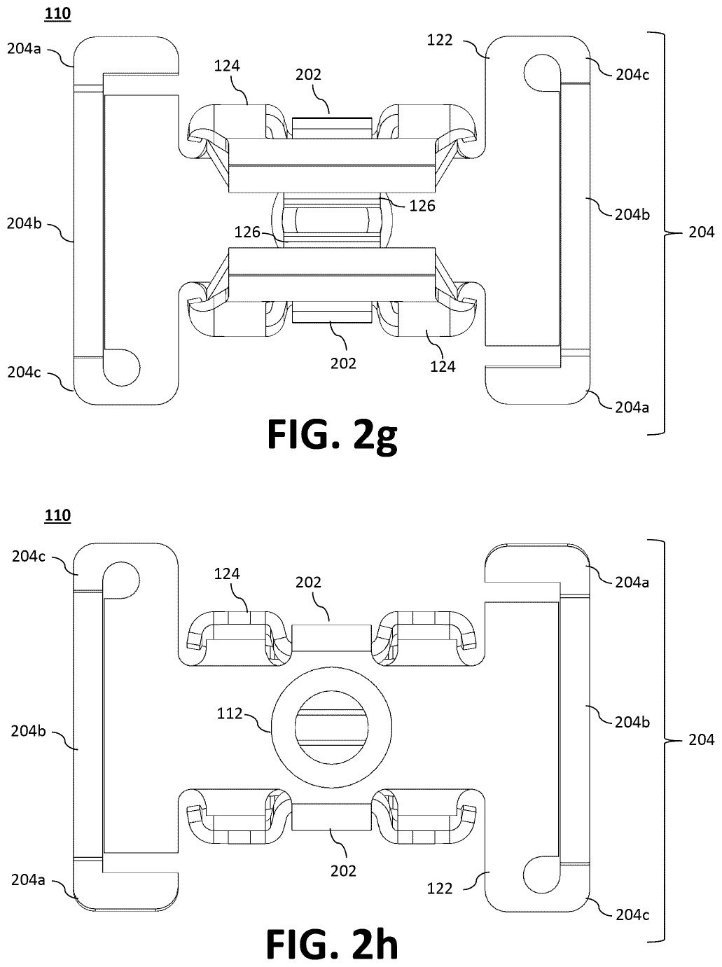

FIG. 2a illustrates a topside isometric view of the push-in retainer 110, while FIG. 2b illustrates an underside isometric view of the push-in retainer 110. FIGS. 2c through 2f illustrates first, second, third, and fourth elevation side views of the push-in retainer 110. FIGS. 2g and 2h illustrate, respectively, top and bottom plan views of the push-in retainer 110.

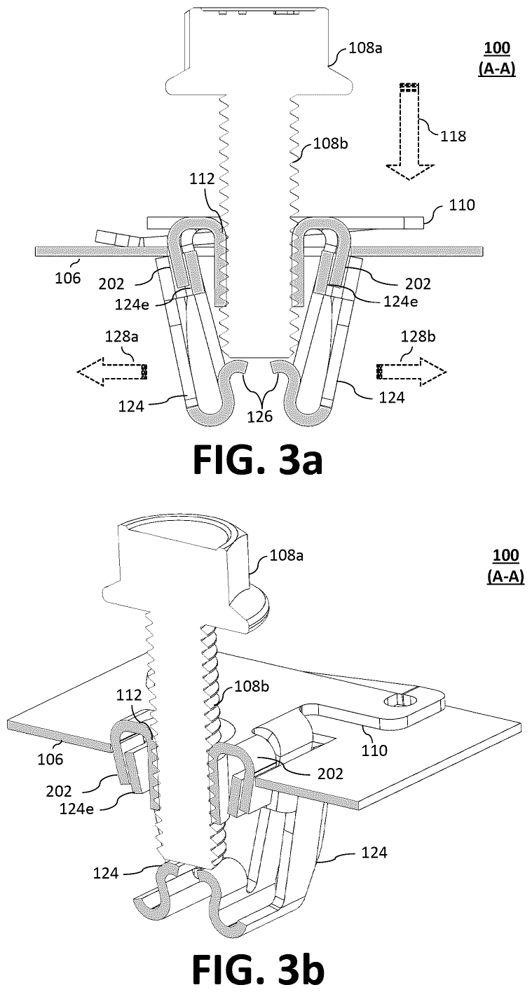

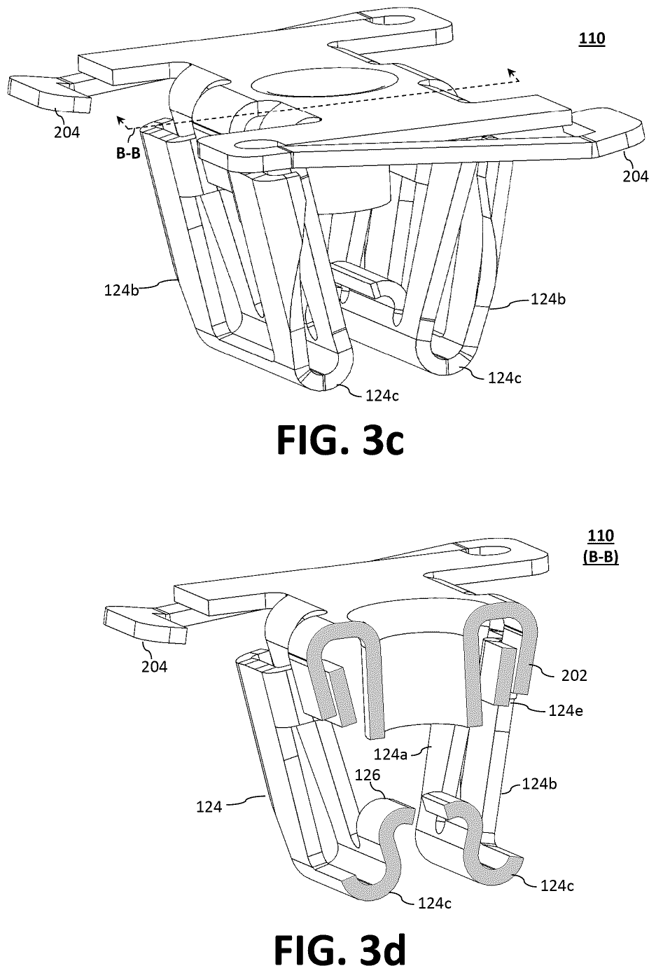

The features of the push-in retainer 110 of FIGS. 2a through 2h are further illustrated in connection with the cross-sectional views of FIGS. 3a through 3d. Specifically, FIG. 3a illustrates a cross-sectional side view of the fastening system 100 taken along cutline A-A (FIG. 1e), while FIG. 3b illustrates a cross-sectional perspective view of the fastening system 100 taken along cutline A-A (FIG. 1e). FIG. 3c illustrates a perspective view of the push-in retainer 110, while FIG. 3d illustrates a cross-sectional perspective view of the push-in retainer 110 taken along cutline B-B (FIG. 3c).

The illustrated push-in retainer 110 comprises a cross member 122 having a pair of retaining legs 124 extending therefrom. The retaining legs 124 are resiliently connected to the cross member 122 at an end thereof (e.g., a proximal end) to form a body having a channel 206 therebetween. The pair of opposing retaining legs 124 are resiliently connected such that the pair of opposing retaining legs 124 default (e.g., spring back) to an initial shape. The push-in retainer 110 further comprises one or more downturn flanges 202 and one or more spring flanges 204.

In one example, each retaining leg 124 is formed as a pair of leg sections 124a, 124b (e.g., a first leg section 124a and a second leg section 124b) that are resiliently connected to one another at their bottom ends via a connecting portion 124c (e.g., a portion that defines the bend, joint, etc.) to form, in one example, a generally U-shaped body. In some examples, the pair of leg sections 124a, 124b is generally parallel to one another. In the illustrated example, the retaining legs 124 are coupled to the cross member 122 via an upper end of the first leg section 124a, while the second leg section 124b is configured to flex relative to the first leg section 124a via the connecting portion 124c. The pair of leg sections 124a, 124b are resiliently connected such that they default to a predetermined shape. Each of retaining legs 124 may include one or more wings 124d extending from a side or edge of the retaining leg 124. The wings 124d serve to increase engagement with the second component 106. In the illustrated example, each second leg section 124b includes a wing 124d. The second leg section 124b can further define a bridge recess 124e (e.g., a portion of the second leg section 124b that is bent/recessed toward the axis of rotation 116).

The push-in retainer 110 further comprises a downturn flange 202, which extends downwardly from the cross member 122 at or near an upper end of the retaining legs 124. For example, the illustrated downturn flange 202 is positioned in a recess of the cross member 122 adjacent the female fastener portion 112. In operation, the downturn flange 202 supports the retaining legs 124 during extraction by engaging an edge of the second opening 120 in the second component 106.

In addition, as best illustrated in FIGS. 3a through 3d, the downturn flange 202 overlaps or otherwise envelopes a portion of the second leg section 124b to limit the amount of outward flex relative to the first leg section 124a via the connecting portion 124c. Specifically, the illustrated downturn flange 202 overlaps with the bridge recess 124e to provide a rigid support to prevent the retaining legs 124 from excessively bending outward.

In addition, the cross member 122 can be further sized and shaped to increase rigidity. For example, the contour of the cross member 122 at or near the connection point of the retaining legs 124 yields increased strength and rigidity compared to a linear section.

Further, in addition to the contour, the one or more spring flanges 204 serve to increase the contact area footprint, thus mitigate risk of damage to the second opening 120 and/or second component 106. In addition, the spring flanges 204 serve to absorb movement between the first component 104 and the second component 106. In the illustrated example, the push-in retainer 110 includes two spring flanges 204, where a spring flange 204 is formed in or otherwise provided on opposed ends of the cross member 122. While other configurations are possible, each of the illustrated spring flanges 204 comprises a foot 204a configured to flex relative to the cross member 122 via an arm 204b and a connecting portion 124c.

During the manufacturing process, a sheet of sheet metal can be can be stamped, bent, and/or otherwise modified to form the cross member 122 and the opposing retaining legs 124, as well as the various other features of the push-in retainer 110, such as the female fastener portion 112, the shelves 126, the downturn flanges 202, and the spring flanges 204. In this example, the first leg section 124a is stamped and bent to provide the material to define the shelves 126 and the downturn flange 202.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A push-in retainer for attaching a first component having a first opening relative to a second component having a second opening via a fastener, the push-in retainer comprising:
a cross member having a female fastener portion configured to engage a threaded shank of the fastener;
a pair of retaining legs resiliently connected to the cross member, wherein the pair of retaining legs comprises a first retaining leg and a second retaining leg; and
one or more downturn flanges coupled to the cross member and extending downwardly from cross member to engage a portion of the first retaining leg or the second retaining leg.

2. The push-in retainer of claim 1, wherein the downturn flange overlaps or otherwise envelopes the portion of the first retaining leg or the second retaining leg.

3. The push-in retainer of claim 1, wherein each of the first retaining leg and the second retaining leg comprises a first leg section and a second leg section resiliently connected to one another via a connecting portion.

4. The push-in retainer of claim 3, wherein the downturn flange is configured to limit outward flex of the second leg section relative to the first leg section via the connecting portion.

5. The push-in retainer of claim 1, wherein cross member includes one or more spring flanges.

6. The push-in retainer of claim 5, wherein the one or more spring flanges are configured to increase a contact area footprint with the second component to mitigate risk of damage thereto.

7. The push-in retainer of claim 5, wherein the one or more spring flanges are configured to absorb movement between the first component and the second component.

8. The push-in retainer of claim 1, wherein the push-in retainer is a stamped-metal component.

9. The push-in retainer of claim 1, wherein each of the first retaining leg and the second retaining leg comprises a shelf, wherein the shelf is configured to bias a respective one of the first retaining leg and the second retaining leg outwardly once the threaded shank passes through the female fastener portion.

10. The push-in retainer of claim 3, wherein the second leg section includes at least one wing configured to engage the second opening.

11. A push-in retainer for attaching a first component having a first opening relative to a second component having a second opening via a fastener, the push-in retainer comprising:
a cross member having a female fastener portion configured to engage a threaded shank of the fastener;
a pair of retaining legs resiliently connected to the cross member,
wherein the pair of retaining legs comprises a first retaining leg and a second retaining leg, and
wherein each of the first retaining leg and the second retaining leg comprises a first leg section and a second leg section resiliently connected to one another via a connecting portion; and
one or more downturn flanges coupled to the cross member and extending downwardly from cross member to engage the second leg section of the first retaining leg or the second retaining leg to limit outward flex of the second leg section relative to the first leg section via the connecting portion.

12. The push-in retainer of claim 11, wherein the push-in retainer is a stamped-metal component.

13. A push-in fastener assembly for attaching a first component having a first opening relative to a second component having a second opening, the push-in fastener assembly comprising:
a fastener having a head and a threaded shank; and
a push-in retainer having
a cross member having a female fastener portion configured to engage the threaded shank,
a pair of retaining legs resiliently connected to the cross member, wherein the pair of retaining legs comprises a first retaining leg and a second retaining leg, and
one or more downturn flanges coupled to the cross member and extending downwardly from cross member to engage a portion of the first retaining leg or the second retaining leg,
wherein each of the first retaining leg and the second retaining leg comprises a shelf, wherein the shelf is configured to bias a respective one of the first retaining leg and the second retaining leg outwardly once the threaded shank passes through the female fastener portion.

14. The push-in fastener assembly of claim 13, wherein each of the first retaining leg and the second retaining leg comprises a first leg section and a second leg section resiliently connected to one another via a connecting portion.

15. The push-in fastener assembly of claim 14, wherein the downturn flange is configured to limit outward flex of the second leg section relative to the first leg section via the connecting portion.

16. The push-in fastener assembly of claim 13, wherein cross member includes one or more spring flanges configured to increase a contact area footprint with the second component to mitigate risk of damage thereto.

17. The push-in fastener assembly of claim 13, wherein cross member includes one or more spring flanges configured to absorb movement between the first component and the second component.

18. The push-in fastener assembly of claim 13, wherein the push-in retainer is a stamped-metal component.

19. The push-in fastener assembly of claim 14, wherein the second leg section includes at least one wing configured to engage the second opening.
